(19) United States
(12) Patent Application Publication
(10) Pub. No.: US 2014/0279619 A1
(43) Pub. Date: Sep. 18, 2014

(54) TALENT PORTAL WITH MEDIA RATING

(71) Applicant: CBS Interactive, Inc., (US)

(72) Inventors: Jon Mantell, Studio City, CA (US); Jeff Burkett, Studio City, CA (US); Robert Gelick, Studio City, CA (US)

(21) Appl. No.: 13/842,727

(22) Filed: Mar. 15, 2013

(51) Int. Cl. G06Q 50/00; H04L 29/08

(52) U.S. Cl. CPC G06Q 50/01; H04L 67/10
USPC 705/319

(57) ABSTRACT

Technology is disclosed for computing a social media rating for a user. In various embodiments, the technology retrieves a broadcast rating, retrieves a social network rating for the user, and computes a social media rating for the user based on the combination of the retrieved broadcast rating and the retrieved social network rating for the user.

### BACKGROUND

The entertainment industry is highly competitive. Many television networks (“broadcasters”), movie studios, and indeed even entertainers (“talent”) compete vigorously for audience attention. The larger the audience a particular network attracts, the more fees it can command from advertisers. The larger the audience a particular talent attracts, the higher the rate the talent can demand.

“NIELSEN ratings” are commonly employed by the television industry to compare the success of television shows. Nielsen ratings were developed during the early days of television broadcasting and are based on observations (e.g., manual or technological) of audience sizes.

An increasing number of talent, networks, and studios are participating in social networking sites. Examples of social networking sites are FACEBOOK, TWITTER, GOOGLE+, etc. One reason the entertainment industry participates in these sites is to increase audience exposure.

A talent's value to a particular show may be based on the talent's influence in social networks. The influence can be measured based on, e.g., “mentions” of the talent's name in social networking sites or other media, “likes” on FACEBOOK, retweets on TWITTER, etc. KLOUT is one entity in the business of generating social networking influence for participants of social networking sites.

### BRIEF DESCRIPTION OF THE DRAWINGS

FIG. 1 is a user interface diagram illustrating aspects of a user interface provided by the disclosed technology in various embodiments.

FIG. 2 is a user interface diagram illustrating aspects of a user interface provided by the disclosed technology in various embodiments.

FIGS. 3A-3E are table diagrams illustrating tables configured to store data employed by the technology in various embodiments.

FIG. 4 is a flow diagram illustrating a routine invoked by the technology in various embodiments to determine a talent rating.

FIG. 5 is a flow diagram illustrating a routine invoked by the technology in various embodiments to determine a social media rating.

### DETAILED DESCRIPTION

A talent portal with media rating (“the technology”) is disclosed. In various embodiments, the technology enables talent to easily engage with social media outlets, observe their overall media value over time, and participate in improving their media value. The technology may combine one or more traditional media ratings (e.g., NIELSEN ratings) with social network influence ratings (e.g., KLOUT score) to produce media ratings for talent. The media ratings can be computed and stored during various time intervals. The talent portal can also enable a “one-stop” location for talent to easily participate in social networking web sites using content that is approved by broadcasters.

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

Turning now to the figures, FIG. 1 is a user interface diagram illustrating aspects of a user interface 100 provided by the disclosed technology in various embodiments. The user interface 100 includes an identification area 102. The identification area 102 can indicate who (e.g., which talent) is logged in. The user interface 100 includes a schedule area 104 for reminding the user about upcoming events. As examples, the technology may remind users about upcoming media and online events that the users may have committed to. The user interface 100 includes a media trend area 106 that can graphically or textually display the user's media information, e.g., over a period of time. The media trend area 106 may also include a compare button 108 and/or an improved button 110. If the user selects the compare button 108, the technology may enable the user to compare is or her media trend information with that of other users (e.g., other talent). If the user selects the improved button 110, the technology may provide some guidance on how the user may improved his or her media trend information, e.g., based on an analysis of the current media trend. Computation of the media trend is described below in relation to FIGS. 4 and 5. The user interface 100 includes a “Recommended Retweets” area 112. The recommended retweets area 112 can provide the user with a set of authorized content that the user can select, e.g., by selecting “Tweet” buttons 114 or 116. When the user selects a Tweet button, a corresponding approved content may be shared (e.g., “tweeted”) using a social network, e.g., TWITTER. The shared content may include a “hashtag,” which is a symbol that commonly associates the shared content with other content shared either previously or in the future. As an example, when Tweet button 114 is selected, approved content 118 may be shared. Similarly, when Tweet button 116 is selected, approved content 120 may be shared. The user interface 100 may include a social network activity area 122. The social network activity area 122 can summarize social networking activity relating to the user, the user's broadcast programs, etc. The social network activity area 22 can include a “See Competition” button 124. When the user selects the “See Competition” button 124, the technology may summarize social network activity relating to other talent. In doing so, a user may be able to compare his or her social network performance with that of other talent. The user interface 100 can include a question region 126 and an answer region 128. The question region 126 can display one or more questions that have been asked of the user or shows in which the user appears. The answer region 128 can display one or more proposed answers, e.g., answers that have been approved for posting. The answer region 128 can also include a post button 129, e.g., that a user can use to post a selected answer. The user interface 100 can also include live update areas, e.g., to display live updates from social networking sites, e.g., a FACEBOOK area 130 and a TWITTER area 132. The user interface 100 can also include the reminders area 134, e.g., that can display reminders to the user of what not to do in addition to what to do.

FIG. 2 is a user interface diagram illustrating aspects of a user interface 200 provided by the disclosed technology in various embodiments. The user interface 200 includes a scheduling area 202 that the user can use to specify a future date and time at which to post social network directions. As an example, talent may desire to post social networking directions at a time when there programs are being aired, e.g., to explain what is happening or to remind users to watch so that additional fans can be driven to watch their programs. The user interface 200 includes a text area 204 in which a user can type a future social network posting. In various embodiments, the user interface 200 can include multiple text areas 204 and 206 corresponding to multiple social networking sites.

FIGS. 3A-3E are table diagrams illustrating tables configured to store data employed by the technology in various embodiments. FIG. 3A is a table diagram illustrating a talent table 300 for tracking users or “talents.” The talent table 300 can include a talent id column 302, a talent name column 304 and a talent contact information column 306. Rows 308, 310, and 312 illustrate example content listing three different actors.

While FIG. 3A and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

FIG. 3B is a table diagram illustrating a show table 320 for tracking shows. The show table 320 can include a show ID column 322, a show name column 324, and a talent ID column 326. Rows 328, 330, 332, and 334 illustrates example content listing shows and talent associated with the shows. In various embodiments, the show name column 324 can be moved to a separate table.

FIG. 3C is a table diagram illustrating a content table 340 for tracking content. The content table 340 can include a content ID column 342, a talent ID column 343, a show ID column 344, a content description ID column 346, and a date range column 348. Rows 350 and 352 illustrate example content listing approved content for various talents and shows.

FIG. 3D is a table diagram illustrating a content table 360 for tracking content descriptions. The content description table 360 can include a content description ID column 362, a hashtag column 364, and a text column 366. Rows 368 and 370 illustrated example content descriptions. As an example, row 368 corresponds to row 350 of FIG. 3C. Row 350 of FIG. 3C corresponds to the show “The Mentalist” and the actor “Simon Baker.” Thus, when Mr. Simon Baker uses the technology, he is approved to share the content “Next week's episode is going to include a special guest appearance by Malcolm McDowell, but in an unusual role. Stay tuned!” When Mr. Baker shares this content, the hashtag corresponding to his present show, “The Mentalist” will also be shared.

FIG. 3 is a table diagram illustrating a scores table 380 for tracking scores or “ratings.” The scores table 380 includes a score ID column 382, a date column 384, a talent ID column 386, a score column 388, and data column 390.

FIG. 4 is a flow diagram illustrating a routine 400 invoked by the technology in various embodiments to determine a talent rating. The routine 400 begins at block 402. At block 404, the routine receives a talent identifier. At block 406, the routine receives a broadcast rating for the identified talent. As an example, the routine may receive a Nielsen rating associated with either the talent, the show(s) in which the talent appears, etc. At block 408, the routine determines a social media rating for the identified talent. Ways to determine social media ratings are explored below in relation to FIG. 5. At block 410, the routine combines the broadcast and the social media ratings for the identified talent. At block 412, the routine stores the combined rating. At block 414, the routine returns.

Those skilled in the art will appreciate that the logic illustrated in FIG. 4 and described above, and in each of the flow diagrams discussed below, may be altered in a variety of ways. For example, the order of the logic may be rearranged, substeps may be performed in parallel, illustrated logic may be omitted, other logic may be included, etc.

FIG. 5 is a flow diagram illustrating a routine 500 invoked by the technology in various embodiments to determine a social media rating. The routine begins at block 502. At block 504, the routine retrieves quantities and qualities a participation in various social network sites. Quality may be measured, e.g., by how closely the content maps to the approved content, what other people are saying about the content, etc. At block 506, the routine retrieves quantity and quality information of the user's “re-tweets.” A re-tweet occurs when a user simply shares a different user's tweets. At block 508, the routine identifies the user's “KLOUT” metrics. As an example, the routine may employ an application program interface provided by a third-party to compute a social network score for the user. At block 510, the routine identifies a social media rating. In various embodiments, the social media rating may be a combination of the user's broadcast rating and social network ratings. The routine then returns at block 512.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing device for computing a social media rating for a user, comprising:
retrieving a broadcast rating;
retrieving a social network rating for the user; and
computing a social media rating for the user based on the combination of the retrieved broadcast rating and the retrieved social network rating for the user.

2. The method of claim 1, wherein the broadcast rating is a traditional media rating.

3. The method of claim 1, wherein the broadcast rating is a network influence rating.

4. The method of claim 1, further comprising indicating the broadcast rating to the actor.

5. The method of claim 4, further comprising indicating a different broadcast rating of a different actor to the actor.

6. The method of claim 5, further comprising identifying at least one action the actor can take to improve the broadcast rating.

7. The method of claim 6, further comprising providing a user interface for the user to participate in social network sites using content approved by a broadcaster.

8. A computer-readable storage medium storing computer-executable instructions, comprising:
instructions for retrieving a broadcast rating;
instructions for retrieving a social network rating for the user; and
instructions for computing a social media rating for the user based on the combination of the retrieved broadcast rating and the retrieved social network rating for the user.

9. The computer-readable storage medium of claim 8, wherein the broadcast rating is a traditional media rating.

10. The computer-readable storage medium of claim 8, wherein the broadcast rating is a network influence rating.

11. The computer-readable storage medium of claim 8, further comprising indicating the broadcast rating to the actor.

12. The computer-readable storage medium of claim 11, further comprising indicating a different broadcast rating of a different actor to the actor.

13. The computer-readable storage medium of claim 12, further comprising identifying at least one action the actor can take to improve the broadcast rating.

14. The computer-readable storage medium of claim 13, further comprising providing a user interface for the user to participate in social network sites using content approved by a broadcaster.

15. A system, comprising:
a central processing unit and a memory;
a component configured to retrieve a broadcast rating;
a component configured to retrieve a social network rating for the user; and
a component configured to compute a social media rating for the user based on the combination of the retrieved broadcast rating and the retrieved social network rating for the user.

16. The system of claim 15, wherein the broadcast rating is a traditional media rating.

17. The system of claim 15, wherein the broadcast rating is a network influence rating.

18. The system of claim 15, further comprising a component configured to indicate the broadcast rating to the actor.

19. The system of claim 18, further comprising indicating a different broadcast rating of a different actor to the actor.

20. The system of claim 19, further comprising identifying at least one action the actor can take to improve the broadcast rating.
